(19) United States
(12) Patent Application Publication
(10) Pub. No.: US 2005/0236588 A1
(43) Pub. Date: Oct. 27, 2005

(54) Radiation shield capsule

(76) Inventor: Moshe Ein-Gal, Ramat Hasharon (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/828,217

(22) Filed: Apr. 21, 2004

(51) Int. Cl. G21F 5/04

(52) U.S. Cl. 250/515.1

(57) ABSTRACT

A system for shielding persons and objects from unwanted radiation including a radiation beam delivery device, and an in-room radiation shield capsule having an aperture for a radiation beam from the radiation beam delivery device to pass therethrough to a patient, the in-room radiation shield capsule attenuating radiation, which is scattered away from the radiation beam delivery device and from the patient, to a personnel-protection level.

### FIELD OF THE INVENTION

The present invention relates generally to systems and methods for shielding persons and objects from unwanted radiation and particularly to a radiation shield capsule.

### BACKGROUND OF THE INVENTION

Lithotripsy, such as extracorporeal shockwave lithotripsy treatment (ESWT) is an extra-corporeal treatment modality for a variety of applications including disintegration of urinary tract calculi, disintegration of any stone-like concretions or depositions of minerals and salts found in ducts, blood vessels or hollow organs of a patient's body, advancing bone union by causing micro-fractures and relieving pain associated with tendons, joints and bony structures. A lithotripter is a device used to perform ESWL, which includes a shockwave head, typically comprising an electrical-to-shockwave energy converter and a focusing mechanism, coupled to a patient's body, in order to deliver shockwave energy to disintegrate the calculi.

Imaging is employed for localization of the calculi and placement of the shock waves, as well as for assessing the progress of the treatment. Often fluoroscopy is used, such as in-line fluoroscopy that captures images during treatment without interfering with the shockwaves. However, fluoroscopy uses ionizing radiation and shielding measures must be taken to protect personnel and others inside and outside the treatment room from radiation scattered from the patient and the equipment. Appropriate building and personnel lead-equivalent shield protection must be provided by the lithotripsy facility, generally in accordance with local regulations.

Lithotripsy is not the only medical field where care must be taken to shield the medical personnel and others from scattered radiation. Radiation therapy devices, such as but not limited to, a linear accelerator (LINAC), generate high-energy radiation beam for therapy. The point of such therapy is to concentrate radiation on tumors or other target zones, but minimize radiation dosages applied to adjacent healthy tissue, especially certain parts of the body (e.g., the optic nerve) that are more sensitive to radiation. Much effort has been made to minimize radiation to healthy tissues, such as moving the radiation source in such a manner so that healthy tissue adjacent the tumor receives radiation for only a small portion of the time, and/or placing radiation shields on the patient to block unwanted radiation to healthy tissues.

However, stray radiation emanating from the radiation therapy device or scattered from the patient may endanger personnel present in the room where the treatment or therapy is taking place as well as people outside the room.

In general, for low energy (imaging) radiation, personnel may stay inside the treatment room while being protected by wearing clothes that contain radiation shields or radiation absorbing material (e.g., lead aprons or cloaks). For high energy (treatment) radiation as well as for low energy radiation, measures are taken to minimize unwanted radiation from straying from the treatment/therapy room, such as radiation shields or radiation absorbing material (e.g., lead panels) placed on or in the walls, ceiling and floor.

### SUMMARY OF THE INVENTION

The present invention seeks to provide novel apparatus and methods for shielding persons and objects from unwanted radiation, as described in detail hereinbelow. The “unwanted” radiation may be, but is not limited to, stray or scattered radiation from radiation devices that do not reach or are not absorbed by image intensifiers or image capturing devices. (The terms scattered and stray are used interchangeably throughout the specification and claims.) The invention may alleviate the requirements (or even obviate the need) for room shielding and in-room personnel shielding.

In accordance with one non-limiting embodiment of the invention, the radiation shield at least partially encapsulates a radiation beam from a radiation source to a patient (or object, in non-clinical cases), while attenuating scattered radiation from the patient. For applications involving detection of radiation (for imaging or diagnosis, for example), the radiation shield also at least partially encapsulates a beam exiting the patient (or object) to the radiation detector. The radiation shield at least partially encapsulates the patient (or object) except for apertures accommodating the entering and the exiting beams. The radiation shield may also at least partially encapsulate the radiation source and the detector, if desired or necessary.

There is thus provided in accordance with an embodiment of the invention a system including a radiation beam delivery device, and an in-room radiation shield capsule having an aperture for a radiation beam from the radiation beam delivery device to pass therethrough to a patient, the in-room radiation shield capsule attenuating radiation, which is scattered away from the radiation beam delivery device and from the patient, to a personnel-protection level.

The system may include further features. For example, in accordance with non-limiting embodiments of the invention, the radiation shield capsule may include a first radiation shield sleeve that at least partially surrounds the radiation beam and a second radiation shield sleeve adapted to at least partially surround the patient. The radiation shield capsule may include a third radiation shield sleeve between the first and second radiation shield sleeves and interfacing therewith, wherein interfaces between the third radiation shield sleeve and the first and second radiation shield sleeves are adapted to attenuate radiation to a personnel-protection level.

The system may further include a radiation detector arranged to detect radiation originating from the radiation source. The radiation shield capsule may include another radiation shield sleeve adapted to at least partially surround a beam between the patient and the radiation detector. Any of the radiation shield sleeves may be coupled to be movable together, or may be movable independently of each other. The radiation shield capsule may be adapted to attenuate electromagnetic wave energy having a frequency at least as high as ultraviolet energy. The system may further include a patient table, wherein the radiation shield capsule at least partially surrounds the patient table. The radiation shield capsule may be shaped to conform to a shape of the patient table and the radiation beam delivery device.

The radiation beam delivery device may form part of a medical treatment system, diagnostic system, or imaging system or any combination thereof.

### BRIEF DESCRIPTION OF THE DRAWINGS

The present invention will be understood and appreciated more fully from the following detailed description taken in conjunction with the drawings in which:

FIG. 1 is a simplified pictorial illustration of a radiation shielding system for shielding persons and objects from unwanted radiation, constructed and operative in accordance with an embodiment of the present invention;

FIG. 2 is a simplified side-view illustration of the radiation shielding system of FIG. 1, with some of the components of the irradiation system omitted for the sake of simplicity;

FIG. 3 is a simplified top-view of an interface between radiation shields of the radiation shielding system of either FIG. 1 or FIG. 2;

FIG. 4 is a simplified pictorial illustration of a radiation shielding system for shielding persons and objects from unwanted radiation, constructed and operative in accordance with another embodiment of the present invention; and

FIG. 5 is a simplified end-view of an interface between radiation shields of the radiation shielding system of FIG. 4.

### DETAILED DESCRIPTION OF EMBODIMENTS

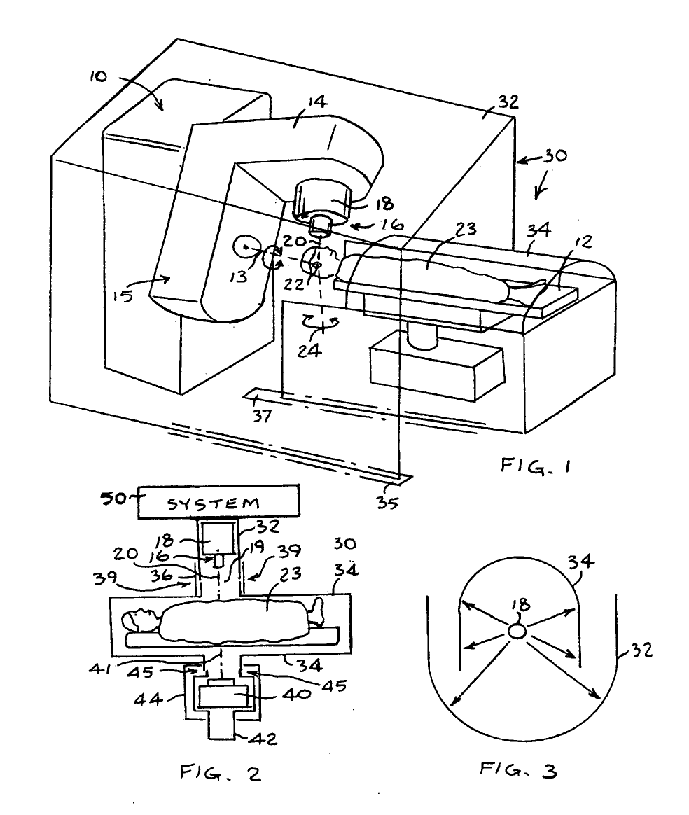

Reference is now made to FIGS. 1 and 2, which illustrate radiation shielding systems for shielding persons and objects from unwanted radiation, constructed and operative in accordance with an embodiment of the present invention. FIG. 1 illustrates an embodiment for use with a radiation system (radiotherapy), such as but not limited to, a LINAC, whereas FIG. 2 illustrates basically the same shielding system (simplified in the illustration for the sake of clarity) for use with radiation imaging equipment (e.g., having a radiation source and an image intensifier or image capturing device) useful in many medical procedures and systems that use radiation imaging devices, such as but not limited to, lithotripsy. It is emphasized that the invention is not limited to these examples and the radiation shielding systems described herein may be used for other applications as well.

The present invention may be used, in the non-limiting embodiment illustrated in FIG. 1, with a radiation system 10 that includes a patient table 12 and a radiation beam delivery device 14, such as a gantry of an irradiation device 15 (e.g., a LINAC [linear accelerator] system). Radiation beam delivery device 14 may be positioned in a plurality of spatial orientations relative to patient table 12, as is well known in the art. For example, radiation beam delivery device 14 may be rotated about a longitudinal axis 13, such as by means of a motor (not shown) and the like. A treatment head 16 may be fastened to a portion of radiation beam delivery device 14, containing a source of radiation 18 for producing a beam of radiation 20, such as but not limited to, electron, photon or any other radiation used in therapy.

In the embodiment of FIG. 2, the source of radiation 18 forms part of a medical treatment, diagnostic and/or imaging system 50, such as but not limited to, a lithotripter, radiographic monitoring system, CT imaging system, PET imaging system, and the like.

During the treatment, the radiation beam 20 is trained on a target 22 of an object 23, for example, a patient who is to be treated. The longitudinal axis 13, a rotational axis 24 of patient table 12, and the beam axis of the beam 20 intersect at a point called the isocenter. The patient 23 is positioned so that the isocenter lies in the target 22.

As opposed to the prior art that may place radiation shields or radiation absorbing material in the walls, ceiling and floor of the treatment room, in the present invention an in-room radiation shield capsule 30 is provided. The radiation shield capsule 30 at least partially surrounds the patient 23 (and patient table 12) and the radiation beam 20 (and possibly radiation beam delivery device 14), and can attenuate scattered radiation to a personnel-protection level. The “personnel-protection level” is defined as a radiation intensity over a predefined time duration, which is not considered to be harmful to persons, such as governed by safety codes. The radiation shield capsule 30 has an aperture 19 for the radiation beam 20 from radiation beam delivery device 14 to pass therethrough to patient 23.

In other words, the radiation shield capsule 30 permits primary (e.g., direct) radiation from radiation beam delivery device 14 to pass to patient 23, while attenuating radiation, which is scattered away from radiation beam delivery device 14 and patient 23, to a personnel-protection level.

The radiation shield capsule 30 may include a first radiation shield sleeve 32 that at least partially surrounds the radiation beam 20 (and possibly radiation source 18) and a second radiation shield sleeve 34 that at least partially surrounds patient table 12. The first radiation shield sleeve 32 may be fixed to a portion of the radiation beam delivery device 14. Alternatively, the first radiation shield sleeve 32 may be movably attached to a portion of the radiation beam delivery device 14, such as by mounting on a track or slide 35. Similarly, the second radiation shield sleeve 34 may be fixed to a portion of the patient table 12. Alternatively, the second radiation shield sleeve 34 may be movably attached to a portion of the patient table 12, such as by mounting on a track or slide 37.

FIG. 3 shows an interface between first and second radiation shield sleeves 32 and 34. It is seen that the radiation shield sleeves 32 and 34 can effectively block radiation without necessarily having to be joined together. As seen in FIG. 2, the radiation shield capsule 30 may also include a third radiation shield sleeve 36 placed between and interfacing with first and second radiation shield sleeves 32 and 34. “Interfacing” encompasses any kind of overlapping and joining, or any combination thereof. The interfaces (indicated by arrows 39) between third radiation shield sleeve 36 and first and second radiation shield sleeves 32 and 34 can also attenuate stray radiation to the personnel-protection level.

The radiation shield sleeves of radiation shield capsule 30 may comprise any suitable radiation absorbing material or radiation impervious material, such as but not limited to, lead. The radiation shield capsule 30 may attenuate electromagnetic wave energy having a frequency at least as high as ultraviolet energy, including without limitation, x-ray or gamma ray energy.

The radiation system 10 may be used for radiation treatment of any kind, such as but not limited to, stereotactic radiosurgery. The radiation system 10 may also be used for imaging purposes, and may include a radiation detector 40 arranged to detect radiation originating from radiation source 18, such as but not limited to, a gamma ray detector or an x-ray detector, as is well known in the art of imaging. In such an embodiment, the radiation shield capsule 30 may also include a fourth radiation shield sleeve 42 that at least partially surrounds a beam 41 between the patient and radiation detector 40.

The radiation shield capsule 30 may further include a fifth radiation shield sleeve 44 placed between and interfacing with the fourth and second radiation shield sleeves 42 and 34. As above, interfaces (indicated by arrows 45) between the fifth radiation shield sleeve 44 and the second and fourth radiation shield sleeves 34 and 42 may attenuate stray radiation to the personnel-protection level.

The fourth radiation shield sleeve 42 may be fixed to a portion of the radiation detector 40. Alternatively, the fourth radiation shield sleeve 42 may be movably attached to a portion of the detector 40, such as by mounting on a track or slide 43.

In an embodiment of the present invention, any of the radiation shield sleeves may be moved independently of each other. The sleeves permit relative motion between the patient and the radiation source 18 and/or the radiation detector 40, and facilitate patient placement. The sleeves need not change their dimensions during usage.

The radiation shield capsule 30 may have any shape or size. For example, the radiation shield capsule 30 may be shaped to conform to a shape of patient table 12 and radiation beam delivery device 14.

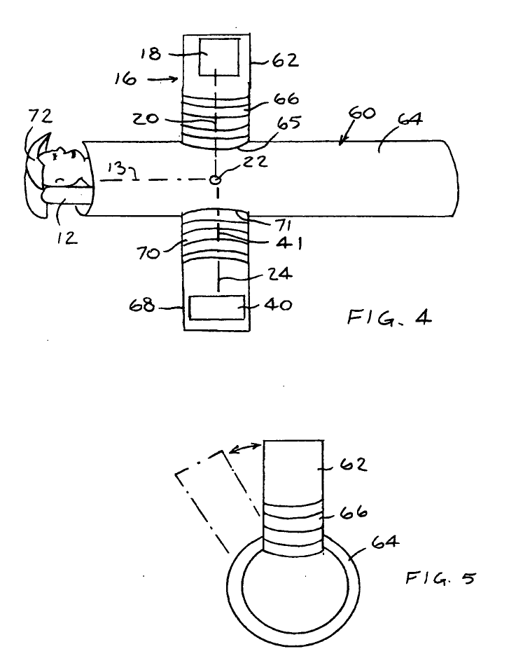

Reference is now made to FIGS. 4 and 5, which illustrate a radiation shielding system for shielding persons and objects from unwanted radiation, constructed and operative in accordance with an embodiment of the present invention. The shielding system is very similar to that shown previously, and the similar elements will be described in brief. Identical elements are designated with identical numerals.

The shielding system may include an in-room radiation shield capsule 60 that at least partially surrounds patient table 12 and radiation beam delivery device 14, and can attenuate stray radiation to a personnel-protection level. The radiation shield capsule 60 may include a first radiation shield sleeve 62 that at least partially surrounds the radiation beam 20 (and possibly radiation source 18) and a second radiation shield sleeve 64 that at least partially surrounds patient table 12. The first radiation shield sleeve 62 may be fixed to a portion of the radiation beam delivery device 64. Similarly, the second radiation shield sleeve 64 may be fixed to a portion of the patient table 12. The radiation shield capsule 60 may also include a third radiation shield sleeve 66 placed between and interfacing with first and second radiation shield sleeves 62 and 64, fitting into an aperture 65 formed in second radiation shield sleeve 64. The third radiation shield sleeve 66 may be flexible and extendable, for example, having a construction like a bellows.

The radiation system may also be used for imaging purposes and may include radiation detector 40, in which case the radiation shield capsule 60 may also include a fourth radiation shield sleeve 68 that at least partially surrounds beam 41 between the patient and radiation detector 40. A fifth radiation shield sleeve 70 may be placed between and interfacing with the fourth and second radiation shield sleeves 68 and 64, fitting into an aperture 71 formed in second radiation shield sleeve 64. Another radiation shield 72 may be placed near the patient's head for blocking stray radiation thereat.

As seen in FIG. 5, the first and second radiation shield sleeves 62 and 64 may be coupled (joined in any manner) to move together in rotational motion about the patient. Of course, the sleeves can move together in translation or other kinds of motion, and alternatively, may move independently of each other.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

1. A system comprising:
a radiation beam delivery device; and
an in-room radiation shield capsule having an aperture for a radiation beam from said radiation beam delivery device to pass therethrough to a patient, said in-room radiation shield capsule attenuating radiation, which is scattered away from said radiation beam delivery device and from the patient, to a personnel-protection level.

2. The system according to claim 1, wherein said radiation shield capsule comprises a first radiation shield sleeve that at least partially surrounds said radiation beam and a second radiation shield sleeve adapted to at least partially surround the patient.

3. The system according to claim 2, wherein said radiation shield capsule comprises a third radiation shield sleeve between said first and second radiation shield sleeves and interfacing therewith, wherein interfaces between said third radiation shield sleeve and said first and second radiation shield sleeves are adapted to attenuate radiation to a personnel-protection level.

4. The system according to claim 1, further comprising a radiation detector arranged to detect radiation originating from said radiation source.

5. The system according to claim 4, wherein said radiation shield capsule comprises another radiation shield sleeve adapted to at least partially surround a beam between the patient and said radiation detector.

6. The system according to claim 2, wherein said first and second radiation shield sleeves are coupled to be movable together.

7. The system according to claim 2, wherein said first and second radiation shield sleeves are movable independently of each other.

8. The system according to claim 3, wherein said third radiation shield sleeve is movable independently of said first and second radiation shield sleeves.

9. The system according to claim 4, wherein said other radiation shield sleeve is movable independently of the patient and said radiation detector.

10. The system according to claim 1, wherein said radiation shield capsule is adapted to attenuate electromagnetic wave energy having a frequency at least as high as ultraviolet energy.

11. The system according to claim 1, further comprising a patient table, wherein said radiation shield capsule at least partially surrounds said patient table.

12. The system according to claim 11, wherein said radiation shield capsule is shaped to conform to a shape of said patient table and said radiation beam delivery device.

13. The system according to claim 1, wherein said radiation beam delivery device forms part of a medical treatment system.

14. The system according to claim 1, wherein said radiation beam delivery device forms part of a diagnostic system.

15. The system according to claim 1, wherein said radiation beam delivery device forms part of an imaging system.
